(19) United States
(12) Patent Application Publication
(10) Pub. No.: US 2015/0334559 A1
(43) Pub. Date: Nov. 19, 2015

(54) TRIGGER EVENT BASED RESPONSE EXECUTION WITH MOTION DETECTION

(71) Applicant: The Button Corporation, Helsinki (FI)

(72) Inventors: Juuso Pesola, Helsinki (FI); Jari Leminen, Helsinki (FI); Sami Ponkanen, Helsinki (FI); Harri Rautio, Helsinki (FI); Erkki Heilakka, Helsinki (FI)

(21) Appl. No.: 14/617,069

(22) Filed: Feb. 9, 2015

Related U.S. Application Data
(63) Continuation-in-part of application No. 14/278,604, filed on May 15, 2014.
Application No. 14/278,604 is a continuation-in-part of application No. 14/278,620, filed on May 15, 2014.
Application No. 14/278,620 is a continuation-in-part of application No. 14/278,635, filed on May 15, 2014.
Application No. 14/278,635 is a continuation-in-part of application No. 14/278,647, filed on May 15, 2014.
Application No. 14/278,647 is a continuation-in-part of application No. 14/278,669, filed on May 15, 2014.

(51) Int. Cl. H04W 8/22

(52) U.S. Cl. CPC H04W 8/22

(57) ABSTRACT

An identification message is sent from a sensor apparatus, over a wireless communication network, in response to a trigger event sensed by a sensor device comprised in the sensor apparatus. The identification message consists of a unique identifier of the sensor apparatus. The identification message is received at a network server. A pre-configured action profile associated with the unique identifier in the received identification message is accessed by the network server. A response action is caused to be executed based on information in the accessed action profile. The sensor apparatus is configured to monitor for changes in the wireless signal strength, and the trigger event consists of at least one of a predetermined change and a predetermined pattern in the monitored wireless signal strength.

### BACKGROUND OF THE INVENTION

1. Field of the Invention

The invention relates to data communications. In particular, the invention relates to trigger event based response execution with motion detection.

2. Description of the Related Art

Various Internet and mobile telecommunications related services have proliferated during the last decade.

While there have been efforts to simplify using these services, they still typically require several actions from the end-user and/or complex set-up operations.

Accordingly, an object of the present invention is to alleviate the problems described above and to introduce a solution that allows an extremely simple way to interact with e.g. various Internet and mobile telecommunications related services, for example by a single button press, and that allows motion detection in the vicinity of the sensor apparatus and sending an alarm if the button is not pressed within a predetermined time.

### SUMMARY OF THE INVENTION

A first aspect of the present invention is a system that comprises a sensor apparatus that is configured to send an identification message over a wireless communication network in response to a trigger event sensed by a sensor device comprised in the sensor apparatus. The identification message consists of a unique identifier of the sensor apparatus. The system further comprises a network server that is configured to receive the identification message, access a pre-configured action profile associated with the unique identifier in the received identification message, and cause a response action to be executed based on information in the accessed action profile. The sensor apparatus is further configured to monitor for changes in the wireless signal strength, and the trigger event consists of at least one of a predetermined change and a predetermined pattern in the monitored wireless signal strength.

A second aspect of the present invention is a method in which an identification message is sent from a sensor apparatus, over a wireless communication network, in response to a trigger event sensed by a sensor device comprised in the sensor apparatus. The identification message consists of a unique identifier of the sensor apparatus. The identification message is received at a network server. A pre-configured action profile associated with the unique identifier in the received identification message is accessed by the network server. The network server causes a response action to be executed based on information in the accessed action profile. The method further comprises monitoring, by the sensor apparatus, for changes in the wireless signal strength, and the trigger event consists of at least one of a predetermined change and a predetermined pattern in the monitored wireless signal strength.

A third aspect of the present invention is a sensor apparatus that comprises a sensor device configured to sense a trigger event. The sensor apparatus further comprises a wireless transceiver configured to send an identification message over a wireless communication network to a network server in response to the trigger event sensed by sensor device. The identification message consists of a unique identifier of the sensor apparatus. The sensor apparatus further comprises a monitoring unit configured to monitor for changes in the wireless signal strength, and the trigger event consists of at least one of a predetermined change and a predetermined pattern in the monitored wireless signal strength.

A fourth aspect of the present invention is a network server that comprises at least one processor and at least one memory including computer program code. The at least one memory and the computer program code are configured to, with the at least one processor, cause the network server at least to perform:

receiving an identification message sent by a sensor apparatus over a wireless communication network in response to a trigger event sensed by a sensor device comprised in the sensor apparatus, the identification message consisting of a unique identifier of the sensor apparatus;

accessing a pre-configured action profile associated with the unique identifier in the received identification message; and

causing a response action to be executed based on information in the accessed action profile,

wherein an alarm cancel event consists of pressing a button comprised in the sensor apparatus, and the response action comprises generating an alarm message about motion detected in the vicinity of the sensor apparatus and sending the generated alarm message to a recipient defined in the action profile in response to not receiving an indication of the alarm cancel event from the sensor apparatus within a predetermined time period.

In an embodiment of the invention, the predetermined change in the monitored wireless signal strength comprises suddenness of the monitored wireless signal strength change exceeding a predetermined threshold.

In an embodiment of the invention, the sensor apparatus comprises a button, an alarm cancel event consists of touching and pressing the button, and the response action comprises generating an alarm message about motion detected in the vicinity of the sensor apparatus and sending the generated alarm message to a recipient defined in the action profile in response to not receiving, at the network server, an indication of the alarm cancel event from the sensor apparatus within a predetermined time period.

In an embodiment of the invention, the alarm message comprises one of a text messaging service message, an electronic mail message, and a hypertext transfer protocol -based message.

In an embodiment of the invention, the wireless communication network comprises at least one of a wireless local area network and a mobile telephone network.

In an embodiment of the invention, the information in the action profile comprises recipient data, and content of the alarm message.

It is to be understood that the aspects and embodiments of the invention described above may be used in any combination with each other. Several of the aspects and embodiments may be combined together to form a further embodiment of the invention. A system, a method, a sensor apparatus, or a network server which is an aspect of the invention may comprise at least one of the embodiments of the invention described above.

The invention allows an extremely simple and inexpensive way to interact with e.g. various Internet and mobile telecommunications related services, for example by a single button press. The invention further allows motion detection in the vicinity of the sensor apparatus and sending an alarm if the button is not pressed within a predetermined time, thereby enabling use of the sensor apparatus e.g. as an anti-theft devices.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a system according to an embodiment of the invention;

FIG. 2 is a signaling diagram illustrating a method according to an embodiment of the invention; and

FIGS. 3a-3b are block diagrams illustrating apparatuses according to an embodiment of the invention.

### DETAILED DESCRIPTION OF THE PREFERRED EMBODIMENTS

Reference will now be made in detail to the embodiments of the invention, examples of which are illustrated in the accompanying drawings.

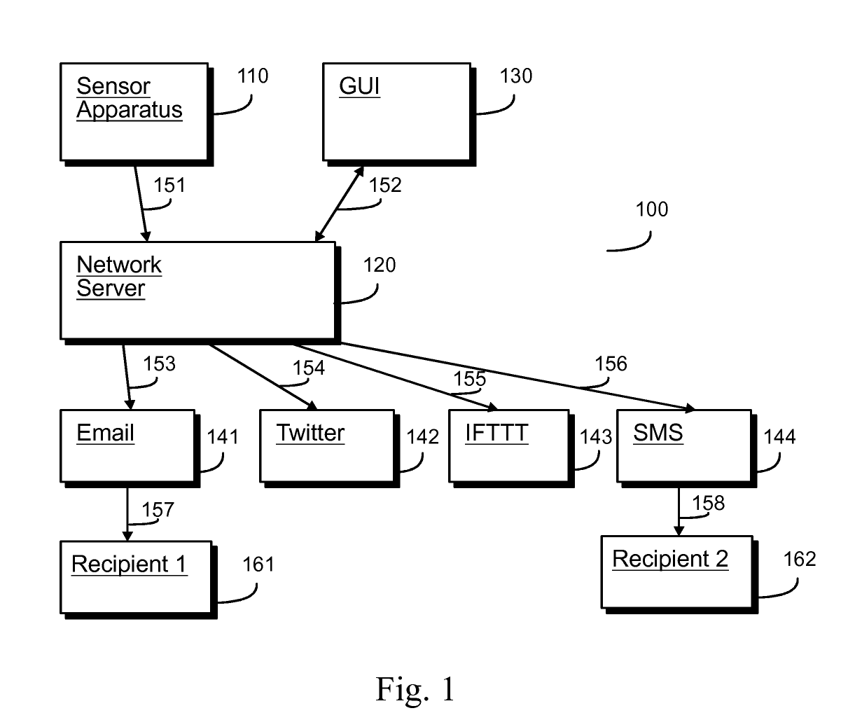

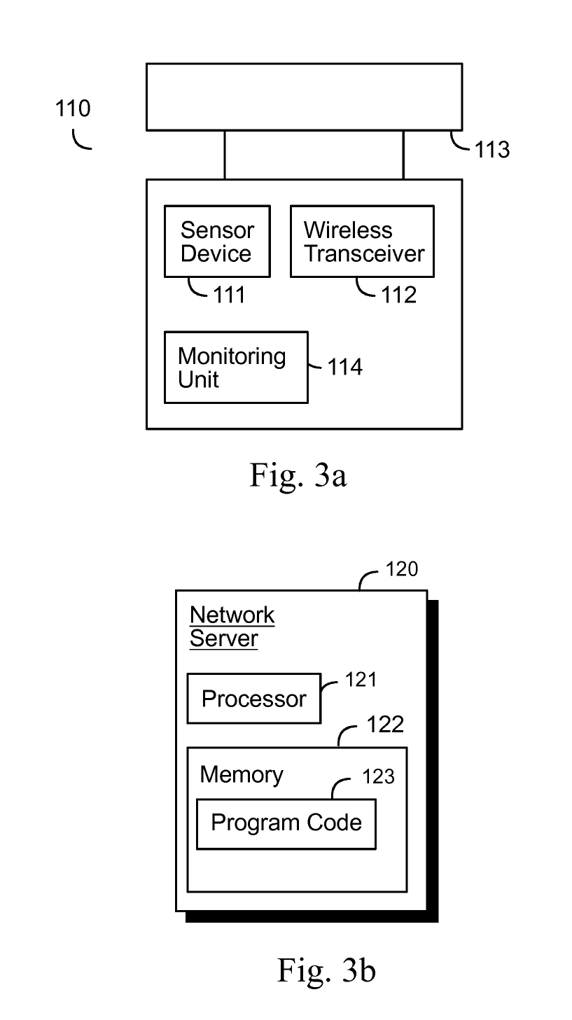

FIG. 1 is a block diagram illustrating a system 100 according to an embodiment of the invention. The system 100 comprises a sensor apparatus 110 that is configured to send an identification message over a wireless communication network in response to a trigger event sensed by a sensor device 111 comprised in the sensor apparatus, as shown in more detail in FIG. 3a. Furthermore, the sensor apparatus 110 may comprise a wireless transceiver 112 that is configured to send an identification message over a wireless communication network to a network server 120 in response to the trigger event sensed by the sensor device 111. The sensor apparatus 110 is further configured to monitor for changes in its wireless signal strength, and the trigger event consists of at least one of a predetermined change and a predetermined pattern in the monitored wireless signal strength. The predetermined change in the monitored wireless signal strength may comprise e.g. suddenness of the monitored wireless signal strength change exceeding a predetermined threshold.

This may be implemented so that the sensor apparatus 110 comprises a monitoring unit 114 that is configured to monitor for the changes in the wireless signal strength.

The identification message consists of a unique identifier of the sensor apparatus 110. The unique identifier may be e.g. a string of alphanumeric characters.

As also shown in FIG. 3a, the sensor apparatus 110 may comprise a button 113. In this case, an alarm cancel event may consist of pressing the button 113. Further in this case, the sensor device 111 may comprise e.g. a switch arrangement responsive to the button 113.

The system 100 further comprises a network server 120 that is configured to receive the identification message, access a pre-configured action profile, i.e. a data set, associated with the unique identifier in the received identification message, and cause a response action to be executed based on information in the accessed action profile. Herein, the response action may comprise generating an alarm message about motion detected in the vicinity of the sensor apparatus and sending the generated alarm message to a recipient defined in the action profile in response to not receiving an indication of the alarm cancel event (i.e. the button press) from the sensor apparatus within a predetermined time period.

As shown in more detail in FIG. 3b, the network server 120 may comprise at least one processor 121 and at least one memory 122 including computer program code 123. The at least one memory 122 and the computer program code 123 are configured to, with the at least one processor 121, cause the network server 120 at least to perform:

receiving the identification message sent by the sensor apparatus 110 over a wireless communication network in response to a trigger event sensed by the sensor device 111 comprised in the sensor apparatus 110, the identification message consisting of a unique identifier of the sensor apparatus 120;

accessing a pre-configured action profile associated with the unique identifier in the received identification message; and

causing a response action to be executed based on information in the accessed action profile, wherein an alarm cancel event consists of pressing a button comprised in the sensor apparatus, and the response action comprises generating an alarm message about motion detected in the vicinity of the sensor apparatus and sending the generated alarm message to a recipient defined in the action profile in response to not receiving an indication of the alarm cancel event from the sensor apparatus within a predetermined time period.

The alarm message may be in the form of a text messaging service message, an electronic mail message, or a hypertext transfer protocol-based message. Examples of the text messaging service message include short message service (SMS) messages and multimedia messaging service (MMS) messages. Examples of the hypertext transfer protocol-based message include Facebook posts, Twitter tweets, and a http-request to a given system.

The system 100 may further comprise one or more network nodes 141, 142, 143 or 144 which are configured to receive the generated alarm message. Examples of the network nodes include an email server 141, a Twitter related network node 142, such as a server, an IFTTT related network node 143, such as a server, and a short message service center (SMSC).

The system 100 may further comprise a graphic user interface 130 that is configured to enable editing of the information in the action profile. The graphic user interface 130 may be accessed e.g. via an internet browser (running e.g. on a laptop computer or a desktop computer) and/or a mobile device application (running e.g. on a smart phone or a tablet computer). The information in the action profile may comprise e.g. recipient data, and content of the action message. The information in the action profile is edited by the user/owner of the sensor apparatus (110) so that he/she can e.g. self-configure the alarm message to his/her liking.

The wireless communication network may comprise at least one of a wireless local area network (WLAN) and a mobile telephone network. Accordingly, the connection 151 in FIG. 1 comprises a wireless communication connection. The mobile telephone network may comprise e.g. a 2G, a 3G or a 4G mobile telephone network. The connections 152-157 may comprise e.g. wired or wireless Internet connections. The connection 158 may comprise e.g. a mobile telephone connection. However, it is to be understood that these connection types are merely examples, and other communication connection types may additionally/alternatively be utilized.

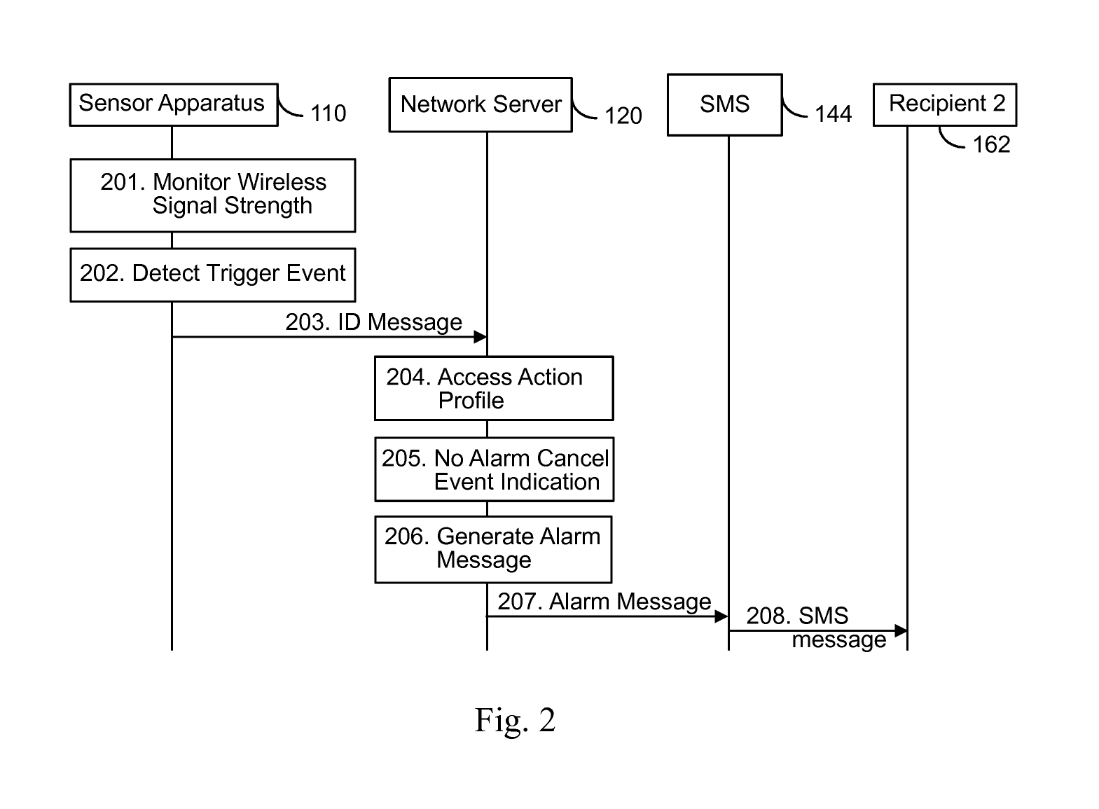

FIG. 2 is a signaling diagram illustrating a method according to an embodiment of the present invention. In this embodiment, the response action comprises generating an alarm message about motion detected in the vicinity of the sensor apparatus and sending the generated alarm message to a recipient defined in the action profile in response to not receiving, at the network server, an indication of the alarm cancel event from the sensor apparatus within a predetermined time period In the embodiment of FIG. 2, the action message comprises an SMS message, but as discussed above, the invention is not restricted to SMS messages. At step 201, the sensor apparatus 110 monitors for changes in its wireless signal strength. A trigger event is sensed by the sensor device 111 comprised in the sensor apparatus 110, step 202. Herein, the trigger event consists of at least one of a predetermined change and a predetermined pattern in the monitored wireless signal strength. The predetermined change in the monitored wireless signal strength may comprise e.g. suddenness of the monitored wireless signal strength change exceeding a predetermined threshold. In response, the identification message is sent from the sensor apparatus 110 over the wireless communication network, step 203. As discussed above, the identification message consists of a unique identifier of the sensor apparatus 110. The identification message is received at a network server 120.

Herein, the sensor apparatus 110 may comprise a button 113, and an alarm cancel event may consist of pressing the button 113. A pre-configured action profile associated with the unique identifier in the received identification message is accessed by the network server 120, step 204. In the embodiment of FIG. 2, at step 205, an indication of the alarm cancel event (i.e. the button press) is not received at the network server 120 from the sensor apparatus 110 within a predetermined time period. In response, steps 206-208 are performed based on information in the accessed action profile. An alarm message about motion detected in the vicinity of the sensor apparatus 110 is generated by the network server 120 based on information in the accessed action profile, step 206. The generated alarm message is sent e.g. to the network node 144 based on the information in the accessed action profile, step 207. The generated alarm message is received at the network node 144. In the example of FIG. 2, the network node 144 sends an SMS alarm message to the recipient 162 of recipients 161-162, step 208. As discussed above, the contents and the recipient address (e.g. a telephone number in this case) of the SMS message have been preconfigured by editing the action profile.

If the indication of the alarm cancel event is received at the network server 120 from the sensor apparatus 110 within the predetermined time period, steps 206-208 of FIG. 2 are not performed. In this case, the response action may comprise e.g. resetting a counter counting the predetermined time period.

The exemplary embodiments can include, for example, any suitable servers, workstations, PCs, laptop computers, other devices, and the like, capable of performing the processes of the exemplary embodiments. The devices and subsystems of the exemplary embodiments can communicate with each other using any suitable protocol and can be implemented using one or more programmed computer systems or devices.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Passenger Request Broker Architecture (CORBA) passengers, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, and the like. Non-volatile media can include, for example, optical or magnetic disks, magneto-optical disks, and the like. Volatile media can include dynamic memories, and the like. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A system, comprising:
a sensor apparatus, configured to send an identification message over a wireless communication network in response to a trigger event sensed by a sensor device comprised in the sensor apparatus, the identification message consisting of a unique identifier of the sensor apparatus; and
a network server, configured to receive the identification message, access a pre-configured action profile associated with the unique identifier in the received identification message, and cause a response action to be executed based on information in the accessed action profile,
wherein the sensor apparatus is further configured to monitor for changes in the wireless signal strength, and the trigger event consists of at least one of a predetermined change and a predetermined pattern in the monitored wireless signal strength.

2. The system according to claim 1, wherein the predetermined change in the monitored wireless signal strength comprises suddenness of the monitored wireless signal strength change exceeding a predetermined threshold.

3. The system according to claim 1, wherein the sensor apparatus comprises a button, an alarm cancel event consists of pressing the button, and the response action comprises generating an alarm message about motion detected in the vicinity of the sensor apparatus and sending the generated alarm message to a recipient defined in the action profile in response to not receiving, at the network server, an indication of the alarm cancel event from the sensor apparatus within a predetermined time period.

4. The system according to claim 3, wherein the alarm message comprises one of a text messaging service message, an electronic mail message, and a hypertext transfer protocol -based message.

5. The system according to claim 1, wherein the wireless communication network comprises at least one of a wireless local area network and a mobile telephone network.

6. The system according to claim 4, wherein the information in the action profile comprises recipient data, and content of the alarm message.

7. A method, comprising:
sending, from a sensor apparatus, an identification message over a wireless communication network in response to a trigger event sensed by a sensor device comprised in the sensor apparatus, the identification message consisting of a unique identifier of the sensor apparatus;
receiving the identification message at a network server;
accessing, by the network server, a preconfigured action profile associated with the unique identifier in the received identification message; and
causing, by the network server, a response action to be executed based on information in the accessed action profile,
wherein the method further comprises monitoring, by the sensor apparatus, for changes in the wireless signal strength, and the trigger event consists of at least one of a predetermined change and a predetermined pattern in the monitored wireless signal strength.

8. The method according to claim 7, wherein the predetermined change in the monitored wireless signal strength comprises suddenness of the monitored wireless signal strength change exceeding a predetermined threshold.

9. The method according to claim 7, wherein the sensor apparatus comprises a button, an alarm cancel event consists of pressing the button, and the response action comprises generating an alarm message about motion detected in the vicinity of the sensor apparatus and sending the generated alarm message to a recipient defined in the action profile in response to not receiving, at the network server, an indication of the alarm cancel event from the sensor apparatus within a predetermined time period.

10. The method according to claim 9, wherein the alarm message comprises one of a text messaging service message, an electronic mail message, and a hypertext transfer protocol -based message.

11. The method according to claim 9, wherein the information in the action profile comprises recipient data, and content of the alarm message.

12. A sensor apparatus, comprising:
a sensor device configured to sense a trigger event; and
a wireless transceiver configured to send an identification message over a wireless communication network to a network server in response to the trigger event sensed by sensor device, the identification message consisting of a unique identifier of the sensor apparatus,
wherein the sensor apparatus further comprises a monitoring unit configured to monitor for changes in the wireless signal strength, and the trigger event consists of at least one of a predetermined change and a predetermined pattern in the monitored wireless signal strength.

13. The sensor apparatus according to claim 12, wherein the predetermined change in the monitored wireless signal strength comprises suddenness of the monitored wireless signal strength change exceeding a predetermined threshold.

14. The sensor apparatus according to claim 12, wherein the sensor apparatus comprises a button, an alarm cancel event consists of pressing the button, and the wireless transceiver is further configured to send an indication of the alarm cancel event to the network server.

15. A network server, comprising:
at least one processor; and
at least one memory including computer program code;
the at least one memory and the computer program code being configured to, with the at least one processor, cause the network server at least to perform:
receiving an identification message sent by a sensor apparatus over a wireless communication network in response to a trigger event sensed by a sensor device comprised in the sensor apparatus, the identification message consisting of a unique identifier of the sensor apparatus;
accessing a pre-configured action profile associated with the unique identifier in the received identification message; and
causing a response action to be executed based on information in the accessed action profile,
wherein an alarm cancel event consists of pressing a button comprised in the sensor apparatus, and the response action comprises generating an alarm message about motion detected in the vicinity of the sensor apparatus and sending the generated alarm message to a recipient defined in the action profile in response to not receiving an indication of the alarm cancel event from the sensor apparatus within a predetermined time period.
